(19) United States
(12) Patent Application Publication
(10) Pub. No.: US 2003/0237095 A1
(43) Pub. Date: Dec. 25, 2003

(54) Trend analysis of chunked view history/profiles view voting

(75) Inventor: Gutta Srinivas, Yorktown Heights, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/179,351

(22) Filed: Jun. 25, 2002

(51) Int. Cl. H04N 7/16; H04H 9/00; G06F 3/00; H04N 5/445; G06F 13/00; H04N 7/173

(52) U.S. Cl. 725/46; 725/112; 725/113; 725/9

(57) ABSTRACT

A method for identifying a trend in a viewer history. The method including: generating a viewing history indicating a number of occurrences of at least one feature in content accessed by a viewer; dividing the viewing history into two or more viewing history portions each of which corresponds to a first predetermined time interval; dividing each of the two or more viewing history portions into two or more viewing history sub portions, wherein each of the two or more viewing history sub portions corresponds to a second predetermined time interval; estimating a trend for each of the two or more viewing history sub portions; and estimating a trend for each of the two or more viewing history portions based on the estimated trend for its two or more viewing history sub portions.

### BACKGROUND OF THE INVENTION

1. Field of the Invention

The present invention relates generally to trend analysis, and more particularly, to television recommenders for generating television program recommendations.

2. Prior Art

Methods are currently known for building a viewer profile that reflects the viewer's preferences for television programming from histories of television programs watched and not watched. The Tivo™ system, for example, available from Tivo, Inc., of Sunnyvale Calif., allows viewers to rate shows using a “thumbs up and thumbs down” feature and thereby indicate programs that the viewer likes or dislikes. An advantageous feature of these systems is incremental updating where the view history is not permanently stored. Rather, the profile is incrementally updated whenever a small number of new programs become added to the view history. However, one difficultly with such systems is that it is difficult to implement schemes for forgetting the oldest programs in the view history because the temporal nature of the view history is often lost in the viewer profile. Forgetting is advantageous for tracking changes in a viewer's preferences. Keeping entire view histories in memory is usually too costly in terms of memory space.

One example of such a scheme is the temporal chunking concept as described in co-pending U.S. patent application Ser. No. 09/718,256 filed on Nov. 15, 2000 and entitled “Television Program Recommender With Interval-Based Profiles for Determining Time-varying Conditional Probabilities,” the entire contents of which is incorporated by its reference. This co-pending Application utilizes all of the view history in a particular viewing history portion (alternatively referred to therein as a “viewing history window”) for estimating the trend analysis.

### SUMMARY OF THE INVENTION

Therefore it is an object of the present invention to provide a method for identifying a trend in a viewer history that overcomes the disadvantages associated with the prior art.

Accordingly, a method for identifying a trend in a viewer history is provided. The method comprising: generating a viewing history indicating a number of occurrences of at least one feature in content accessed by a viewer; dividing the viewing history into two or more viewing history portions each of which corresponds to a first predetermined time interval; dividing each of the two or more viewing history portions into two or more viewing history sub portions, wherein each of the two or more viewing history sub portions corresponds to a second predetermined time interval; estimating a trend for each of the two or more viewing history sub portions; and estimating a trend for each of the two or more viewing history portions based on the estimated trend for its two or more viewing history sub portions. The content accessed is preferably television programs or web sites. Preferably, at least two of the second predetermined time intervals overlap.

The method preferably further comprises computing a conditional probability for the at least one feature in each of the two or more viewing history portions wherein the estimating of the trend for each of the two or more viewing history sub portions is based on the computed conditional probabilities.

Preferably, the estimated trend for each of the two or more viewing history portions is based on a majority of the estimated trends for its two or more viewing history sub portions.

Also provided is a method for managing the storage of a user profile in a recommender device. The method comprising: observing behavior of the user over time; and generating the user profile as two or more viewing history portions, each of which corresponds to a first predetermined time interval wherein each of the two or more viewing history portions is further divided into two or more viewing history sub portions, each of which corresponds to a second predetermined time interval. Preferably, the user profile is associated with a television program recommender or a web site recommender.

The two or more viewing history sub portions can be consecutive or overlap by a third predetermined time interval.

Preferably, the method further comprises estimating a trend for each of the two or more viewing history portions based on an estimated trend for its two or more viewing history sub portions.

Still provided is a computer program product embodied in a computer-readable medium for identifying a trend in a viewer history. The computer program product comprises: computer readable program code means for generating a viewing history indicating a number of occurrences of at least one feature in content accessed by a viewer; computer readable program code means for dividing the viewing history into two or more viewing history portions each of which corresponds to a first predetermined time interval; computer readable program code means for dividing each of the two or more viewing history portions into two or more viewing history sub portions, wherein each of the two or more viewing history sub portions corresponds to a second predetermined time interval; computer readable program code means for estimating a trend for each of the two or more viewing history sub portions; and computer readable program code means for estimating a trend for each of the two or more viewing history portions based on the estimated trend for its two or more viewing history sub portions.

Preferably, the computer program product further comprises computer readable program code means for computing a conditional probability for the at least one feature in each of the two or more viewing history portions wherein the estimating of the trend for each of the two or more viewing history sub portions is based on the computed conditional probabilities.

The estimated trend for each of the two or more viewing history portions is preferably based on a majority of the estimated trends for its two or more viewing history sub portions.

Still further provided is a program storage device readable by machine, tangibly embodying a program of instructions executable by the machine to perform method steps for identifying a trend in a viewer history. The method comprises: generating a viewing history indicating a number of occurrences of at least one feature in content accessed by a viewer; dividing the viewing history into two or more viewing history portions each of which corresponds to a first predetermined time interval; dividing each of the two or more viewing history portions into two or more viewing history sub portions wherein each of the two or more viewing history sub portions corresponds to a second predetermined time interval; estimating a trend for each of the two or more viewing history sub portions; and estimating a trend for each of the two or more viewing history portions based on the estimated trend for its two or more viewing history sub portions.

The method further preferably comprises computing a conditional probability for the at least one feature in each of the two or more viewing history portions wherein the estimating of the trend for each of the two or more viewing history sub portions is based on the computed conditional probabilities.

The estimated trend for each of the two or more viewing history portions is preferably based on a majority of the estimated trends for its two or more viewing history sub portions.

Still yet further provided is a device for identifying a trend in a viewer history. The device comprising: means for generating a viewing history indicating a number of occurrences of at least one feature in content accessed by a viewer; means for dividing the viewing history into two or more viewing history portions each of which corresponds to a first predetermined time interval; means for dividing each of the two or more viewing history portions into two or more viewing history sub portions, wherein each of the two or more viewing history sub portions corresponds to a second predetermined time interval; means for estimating a trend for each of the two or more viewing history sub portions; and means for estimating a trend for each of the two or more viewing history portions based on the estimated trend for its two or more viewing history sub portions. Preferably, the content accessed is television programs or web sites. Preferably, at least two of the second predetermined time intervals overlap.

The device preferably further comprises means for computing a conditional probability for the at least one feature in each of the two or more viewing history portions wherein the estimating of the trend for each of the two or more viewing history sub portions is based on the computed conditional probabilities.

Preferably, the estimated trend for each of the two or more viewing history portions is based on a majority of the estimated trends for its two or more viewing history sub portions.

### BRIEF DESCRIPTION OF THE DRAWINGS

These and other features, aspects, and advantages of the apparatus and methods of the present invention will become better understood with regard to the following description, appended claims, and accompanying drawings where:

FIG. 1 illustrates a preferred implementation of a device for identifying a trend in a viewer history.

FIG. 2 illustrates the viewing history of FIG. 1 having at lest two viewing history portions.

FIG. 3a illustrates a particular viewing history portion of FIG. 2 having consecutive viewing history sub portions.

FIG. 3b illustrates a particular viewing history portion of FIG. 2 having overlapping viewing history sub portions.

FIG. 4 illustrates a preferred implementation of a method for identifying a trend in a viewer history.

### DETAILED DESCRIPTION OF THE PREFERRED EMBODIMENT

Although this invention is applicable to numerous and various types of content accessed by a viewer, it has been found particularly useful in the environment of television programming. Therefore, without limiting the applicability of the invention to television programming, the invention will be described in such environment. However, those skilled in the art will appreciate that the methods and devices of the present invention can be used in any application where a viewer profile is generated, such as a web profile. For purposes of this disclosure, “viewer” and “user” are used interchangeably herein and are intended to have the same general meaning. “Viewer” should not be so construed to be limited to content that is viewed on a display but to anyone who accesses any type of content.

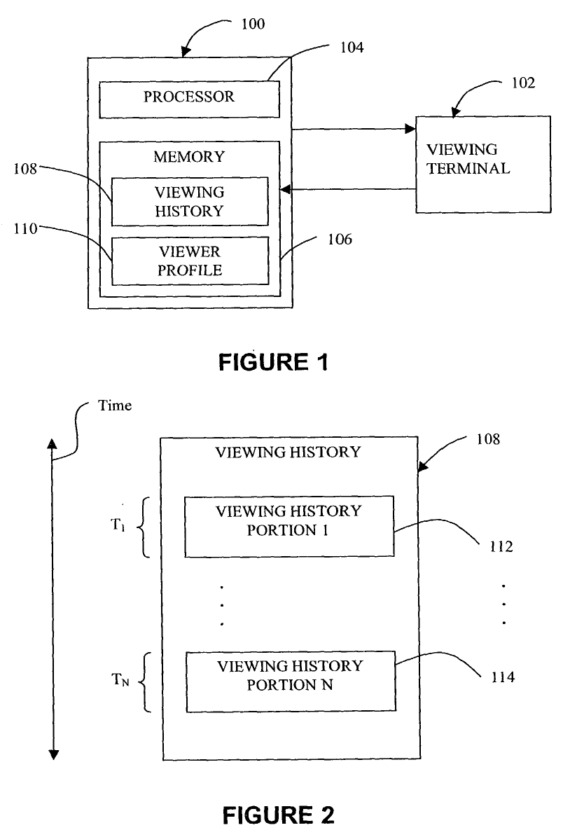

Referring now to FIG. 1, there is illustrated a device generally referred to by reference numeral 100 for identifying a trend in a viewer history. The device 100 is operatively connected to a viewing terminal 102 such as a television, a personal computer, or a PDA (Personal Digital Assistant). The device 100 is preferably configured as a set-top box and operatively connected to the viewing terminal 102 by appropriate cables, but may also be integrally formed therewith. The device 100 has, among other features, a processor 104 and a memory 106. The memory 106 includes, among other features, a viewing history 108 and a viewer profile 110. The viewer profile 110 contains a plurality of records each associated with a different program feature as is discussed in co-pending application Ser. No. 09/718,256.

Referring now to FIG. 2, the viewing history 108 contains a historical listing of the content accessed by the user on the viewing terminal 102. The content accessed is any content accessed by the user on the viewing terminal 102, such as television programs watched (or not watched) by the user or web sites visited by the user. As discussed in co-pending application Ser. No. 09/718,256, the viewing history 108 is preferably maintained as a series of viewing history portions 112 to 114, that allow non-stationary viewing preferences to be identified. The device 100 can maintain the viewing history 108 as a series of consecutive periodic viewing history portions 112 . . . 114, such as one-month intervals. In which case, the viewing history portions 112 . . . 114 correspond to the content accessed by the viewer during time spans T₁ . . . Tₙ, which are each less than the entire time period covered by the viewing history 108. Thus, each viewing history portion 112 . . . 114 is associated with a first predetermined time interval T₁ . . . Tₙ where n is the number of viewing history portions. Although, the time associated with the viewing history portions is referred to herein as a first predetermined time interval, such is not meant to limit the time intervals to be of the same length but is only used to distinguish between other time intervals. In fact, the first predetermined time intervals T₁ . . . Tₙ corresponding with the viewing history portions 112 . . . 114 can have differing time intervals or all have the same time intervals. As will be described below, it is preferred that a conditional probability is determined for each of the viewing history portions 112 . . . 114, thus it is only necessary to maintain the viewing history portions 112 . . . 114 in memory until such is computed.

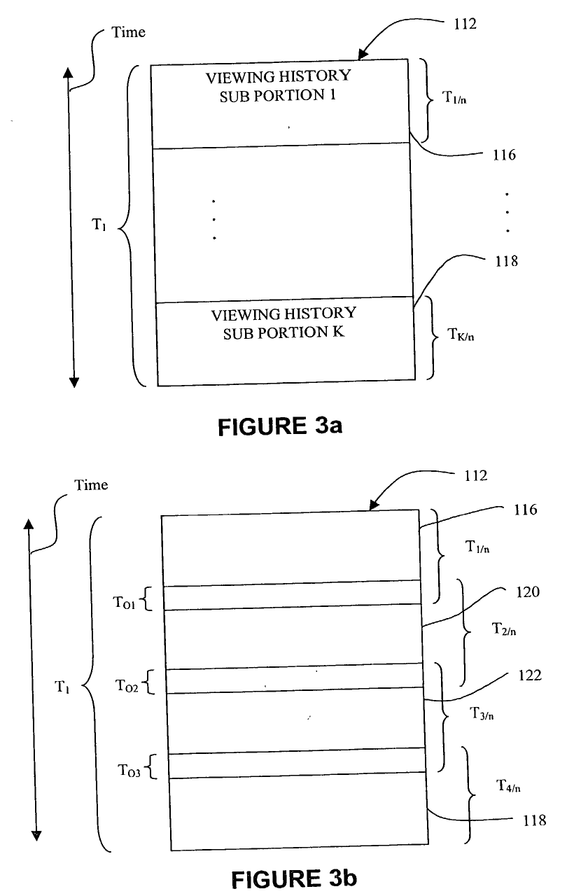

Referring now to FIG. 3a, viewing history portion 112 is shown therein. At least one of the viewing history portions, portion 112 is shown by way of example, are further preferably maintained into two or more viewing history sub portions 116 . . . 118. Similarly to the viewing history portions 112 . . . 114, each of the two or more viewing history sub portions corresponds to a second predetermined time interval T_{1/n} . . . T_{k/n} where k is the number of viewing history sub portions and where the second predetermined time intervals are each less than the entire time interval of the viewing history portion 112. For example, if the view history portion 112 is a month, the view history sub portions can be the alternate days of the month, the first 20 days of the month, and even certain times of each day of the month. The viewing history sub portions 116 . . . 118, like the viewing history portions 112 . . . 114, may be consecutive as shown in FIG. 3a, or overlapping as shown in FIG. 3b. FIG. 3b illustrates a simple example of viewing history portion 112 having four viewing history sub portions 116, 120, 122, and 118 (i.e., k is 4). Each of the viewing history sub portions 116, 120, 122, and 118 corresponds with a time interval T_{1/n}, T_{2/n}, T_{3/n}, and T_{4/n}, respectively. As discussed above with regard to the viewing history portions 112 . . . 114, the time associated with the viewing history sub portions is referred to as a second predetermined time interval herein. However, such is not meant to limit the second predetermined time intervals to be of the same length but is only used to distinguish between other time intervals, such as the time intervals of the viewing history portions 112 . . . 114. In fact, the second predetermined time intervals T_{1/k} . . . T_{n/k} corresponding with the viewing history sub portions 116 . . . 118 can have differing time intervals or all have the same time intervals, as can the overlap in time intervals T_{O1}, T_{O2}, and T_{O3}, alternatively referred to herein as a third predetermined time interval.

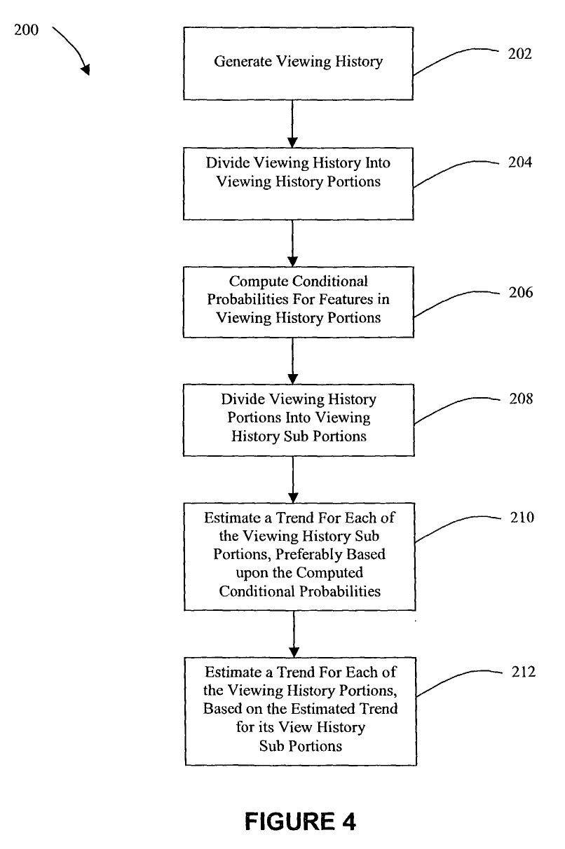

Referring now to FIG. 4, a method for identifying a trend in the viewer history will now be discussed, the method being generally referred to by reference numeral 200. The method 100 comprises generating a viewing history at step 202. The viewing history indicates a number of occurrences of at least one feature in content accessed by a viewer. Building viewing histories from the behavior of a viewer is well known in the art, such as disclosed in co-pending application Ser. No. 09/718,256. As discussed earlier, examples of the content accessed are the viewing of television programs or the visiting of web sites.

At step 204, the viewing history is divided into two or more viewing history portions, each of which corresponds to a first predetermined time interval. For example, the viewing history portions can be one month long or 20 discrete pieces of content, such as 20 television programs. At step 206, the conditional probability (CP) for each feature in each viewing history portion is preferably computed. For example the CP may be computed based on equation 1:

$$CP = \frac{Number of Times Show Having Feature}{Number of Shows in Class} \qquad ( 1 )$$

At step 208, at least one, and preferably all of the viewing history portions are divided into two or more viewing history sub portions. Each of the viewing history sub portions corresponds to a second predetermined time interval. As discussed above, the viewing history sub portions may be consecutive or overlapping. A viewing trend is then estimated at step 210 for each of the viewing history sub portions using known methods, such as that disclosed in co-pending application Ser. No. 09/718,256 which bases such trends on the CP's previously computed.

At step 212, a trend for each of the two or more viewing history portions is estimated based on the estimated trend for its two or more viewing history sub portions. For example if a particular trend obtains the maximum number of votes among all viewing history sub portions, then that trend is chosen as the most likely trend for the viewing history portion. A simple example of voting is where a certain viewing history portion corresponds to a 31-day month, which is divided into 31 viewing history sub portions, each corresponding to a day in the month. If 16 of the viewing history sub portions are estimated to have a linear trend and 15 are estimated to have a cyclical trend, then a linear-trend is chosen for the corresponding view history portion.

The device 100 for identifying a trend in a viewer history as discussed above, in addition to being embodied as a “set-top” box for a television, may be embodied as any computing device, such as a personal computer or workstation having a processor 104 and memory 106. Furthermore, in the case of providing a web-profile, it may be embodied in a web-browser, which is serviced by a server having a processor 104 and memory 106.

The methods of the present invention are particularly suited to be carried out by a computer software program, such computer software program preferably containing modules corresponding to the individual steps of the methods. Such software can of course be embodied in a computer-readable medium, such as an integrated chip or a peripheral device.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A method for identifying a trend in a viewer history, the method comprising:
generating a viewing history indicating a number of occurrences of at least one feature in content accessed by a viewer;
dividing the viewing history into two or more viewing history portions each of which corresponds to a first predetermined time interval;
dividing each of the two or more viewing history portions into two or more viewing history sub portions, wherein each of the two or more viewing history sub portions corresponds to a second predetermined time interval;
estimating a trend for each of the two or more viewing history sub portions; and
estimating a trend for each of the two or more viewing history portions based on the estimated trend for its two or more viewing history sub portions.

2. The method of claim 1, wherein the content accessed is television programs.

3. The method of claim 1, wherein the content accessed is web sites.

4. The method of claim 1, wherein at least two of the second predetermined time intervals overlap.

5. The method of claim 1, further comprising computing a conditional probability for the at least one feature in each of the two or more viewing history portions wherein the estimating of the trend for each of the two or more viewing history sub portions is based on the computed conditional probabilities.

6. The method of claim 1, wherein the estimated trend for each of the two or more viewing history portions is based on a majority of the estimated trends for its two or more viewing history sub portions.

7. A method for managing the storage of a user profile in a recommender device, the method comprising:
observing behavior of the user over time; and
generating the user profile as two or more viewing history portions, each of which corresponds to a first predetermined time interval wherein each of the two or more viewing history portions is further divided into two or more viewing history sub portions, each of which corresponds to a second predetermined time interval.

8. The method of claim 7, wherein the user profile is associated with a television program recommender.

9. The method of claim 7, wherein the user profile is associated with a web site recommender.

10. The method of claim 7, wherein the two or more viewing history sub portions are consecutive.

11. The method of claim 7, wherein the two or more viewing history sub portions overlap by a third predetermined time interval.

12. The method of claim 7, further comprising estimating a trend for each of the two or more viewing history portions based on an estimated trend for its two or more viewing history sub portions.

13. A computer program product embodied in a computer-readable medium for identifying a trend in a viewer history, the computer program product comprising:
computer readable program code means for generating a viewing history indicating a number of occurrences of at least one feature in content accessed by a viewer;
computer readable program code means for dividing the viewing history into two or more viewing history portions each of which corresponds to a first predetermined time interval;
computer readable program code means for dividing each of the two or more viewing history portions into two or more viewing history sub portions, wherein each of the two or more viewing history sub portions corresponds to a second predetermined time interval;
computer readable program code means for estimating a trend for each of the two or more viewing history sub portions; and
computer readable program code means for estimating a trend for each of the two or more viewing history portions based on the estimated trend for its two or more viewing history sub portions.

14. The computer program product of claim 13, further comprising computer readable program code means for computing a conditional probability for the at least one feature in each of the two or more viewing history portions wherein the estimating of the trend for each of the two or more viewing history sub portions is based on the computed conditional probabilities.

15. The computer program product of claim 13, wherein the estimated trend for each of the two or more viewing history portions is based on a majority of the estimated trends for its two or more viewing history sub portions.

16. A program storage device readable by machine, tangibly embodying a program of instructions executable by the machine to perform method steps for identifying a trend in a viewer history, the method comprising:
generating a viewing history indicating a number of occurrences of at least one feature in content accessed by a viewer;
dividing the viewing history into two or more viewing history portions each of which corresponds to a first predetermined time interval;
dividing each of the two or more viewing history portions into two or more viewing history sub portions wherein each of the two or more viewing history sub portions corresponds to a second predetermined time interval;
estimating a trend for each of the two or more viewing history sub portions; and
estimating a trend for each of the two or more viewing history portions based on the estimated trend for its two or more viewing history sub portions.

17. The program storage device of claim 16, wherein the method further comprising computing a conditional probability for the at least one feature in each of the two or more viewing history portions wherein the estimating of the trend for each of the two or more viewing history sub portions is based on the computed conditional probabilities.

18. The program storage device of claim 16, wherein the estimated trend for each of the two or more viewing history portions is based on a majority of the estimated trends for its two or more viewing history sub portions.

19. A device for identifying a trend in a viewer history, the device comprising:
means for generating a viewing history indicating a number of occurrences of at least one feature in content accessed by a viewer;
means for dividing the viewing history into two or more viewing history portions each of which corresponds to a first predetermined time interval;
means for dividing each of the two or more viewing history portions into two or more viewing history sub portions, wherein each of the two or more viewing history sub portions corresponds to a second predetermined time interval;
means for estimating a trend for each of the two or more viewing history sub portions; and
means for estimating a trend for each of the two or more viewing history portions based on the estimated trend for its two or more viewing history sub portions.

20. The device of claim 19, wherein the content accessed is television programs.

21. The device of claim 19, wherein the content accessed is web sites.

22. The device of claim 19, wherein at least two of the second predetermined time intervals overlap.

23. The device of claim 19, further comprising means for computing a conditional probability for the at least one feature in each of the two or more viewing history portions wherein the estimating of the trend for each of the two or more viewing history sub portions is based on the computed conditional probabilities.

24. The device of claim 19, wherein the estimated trend for each of the two or more viewing history portions is based on a majority of the estimated trends for its two or more viewing history sub portions.
